(19) United States
(12) Patent Application Publication
(10) Pub. No.: US 2009/0002345 A1
(43) Pub. Date: Jan. 1, 2009

(54) Systems and Methods for Interacting with Position Data Representing Pen Movement on a Product

(76) Inventor: Stefan Burstrom, Lund (SE)

Correspondence Address: BIRCH STEWART KOLASCH & BIRCH, PO BOX 747, FALLS CHURCH, VA, 22040-0747, US

(21) Appl. No.: 12/224,220

(22) PCT Filed: Feb. 21, 2007
(86) PCT No.: PCT/SE2007/000159

§ 371 Date: Aug. 21, 2008

Related U.S. Application Data
(60) Provisional application No. 60/743,346, filed on Feb. 23, 2006.

(30) Foreign Application Priority Data
Feb. 22, 2006 (SE) 0600384-2

(51) Int. Cl. G06F 3/033; G06F 3/16

(52) U.S. Cl. 345/179

(57) ABSTRACT

A versatile electronic pen (100) includes a system for interacting with position data representing the pen's movement on a product (110) provided with a position-coding pattern (P). The system comprises an audio module which is operable to correlate the position data with audio data and to provide the audio data for output on a speaker device (104). The system also comprises at least one of a position storage module which is operable to store the position data in a persistent-storage memory (102), and a position streaming module which is operable to provide the position data as a bit stream for real-time output on an interface (105) for external communication. The operation of the modules is selectively activated as a function of the position data, and the modules suitably operate independently of each other.

### CROSS-REFERENCE TO RELATED APPLICATIONS

The present application claims the benefit of Swedish patent application No. 0600384-2, filed on Feb. 22, 2006, and U.S. provisional patent application No. 60/743,346, filed on Feb. 23, 2006, both of which being hereby incorporated by reference.

### FIELD OF THE INVENTION

The present invention generally relates to management of digitally recorded data, and in particular to data management processes in relation to an electronic pen.

### BACKGROUND ART

Electronic pens can be used for generation of information that electronically represents handwritten entries on a product surface. One known type of electronic pen operates by capturing images of a coding pattern on the product surface. Based upon the images, the pen is able to electronically record a sequence of positions (a pen stroke) that reflects the pen movement on the product surface.

WO 01/16691 discloses an electronic pen which implements a store-and-send process, in which the pen is storing all recorded pen strokes in an internal memory. The pen can then be commanded to output all or a selected subset of the pen strokes to a receiving device. Thus, the pen is a stand-alone device which offers user control over what, how and when data is output from the pen. In US 2003/0061188, US 2003/0046256 and US 2002/0091711, the present Applicant has suggested different information management systems that may incorporate such a pen.

WO 00/72230 discloses an electronic pen which transmits recorded pen strokes one by one in near real time to a nearby printer that relays the pen strokes to a network server which implements a dedicated service.

WO 2004/084190 discloses an electronic pen with a built-in speaker. The pen may associate different positions on a product surface with different audio content stored in an internal memory of the pen. Whenever the pen records any such positions, it provides the audio content to the user via the speaker.

### SUMMARY OF THE INVENTION

It is an object of the invention to improve the versatility of existing systems and methods for interacting with position data representing pen movement on a product.

Generally, the object of the invention is at least partly achieved by means of systems and methods according to the independent claims, preferred embodiments being defined by the dependent claims.

One aspect of the invention is a system for interacting with position data representing pen movement on a product provided with a position-coding pattern, comprising: a position storage module which is operable to store the position data in a persistent-storage memory; and an audio feedback module which is operable to correlate the position data with audio data and to provide the audio data for output on a speaker device; wherein operation of at least one the position storage module and the audio feedback module is selectively activated as a function of the position data.

Another aspect of the invention is a method of interacting with position data representing pen movement on a product provided with a position-coding pattern, comprising: selectively activating, as a function of the position data, a position storage process and an audio feedback process; wherein the position storage process stores the position data in a persistent-storage memory; and wherein the audio feedback process correlates the position data with audio data and provides the audio data for output on a speaker device.

Yet another aspect of the invention is a system for interacting with position data representing a pen movement on a product provided with a position-coding pattern, comprising: a position streaming module which is operable to provide the position data as a bit stream for output on a communications interface; and an audio feedback module which is operable to correlate the position data with audio data and to provide the audio data for output on a speaker device; wherein operation of at least one the position streaming module and the audio feedback module is selectively activated as a function of the position data.

A still further aspect of the invention is a method of interacting with position data representing pen movement on a product provided with a position-coding pattern, comprising: selectively activating, as a function of the position data, a position streaming process and an audio feedback process; wherein the position streaming process provides the position data as a bit stream for output on a communications interface; and wherein the audio feedback process correlates the position data with audio data and provides the audio data for output on a speaker device.

Still other objectives, features, aspects and advantages of the present invention will appear from the following detailed disclosure, from the attached dependent claims as well as from the drawings.

### BRIEF DESCRIPTION OF THE DRAWINGS

The invention will now be described in more detail with reference to the accompanying schematic drawings.

FIG. 1 illustrates a system for interaction with a coded product.

FIG. 2 is an overview of a process for generating and using position data in an electronic pen according to an embodiment of the invention.

FIG. 3 illustrates a logical division of an abstract position-coding pattern into a tree structure of addressable page units.

FIG. 4 is a cross-sectional view of an electronic pen that may implement the principles of the present invention.

FIG. 5 illustrates the relation of a logic-defining template to a position-coded product.

FIG. 6 illustrates software modules implementing the process of FIG. 2.

FIG. 7 illustrates further details of a Store-and-Send module of FIG. 6

FIG. 8 illustrates a system architecture including an implementation of an audio feedback process in the pen of FIGS. 1 and 4.

FIGS. 9A-9B illustrates different implementations of an Audio module in FIG. 6.

FIG. 10 illustrates steps of a method for generating and installing an audio feedback application in the pen of FIGS. 1 and 4.

FIG. 11 illustrates further details of a Streamer module of FIG. 6.

### DETAILED DESCRIPTION OF THE INVENTION

### General

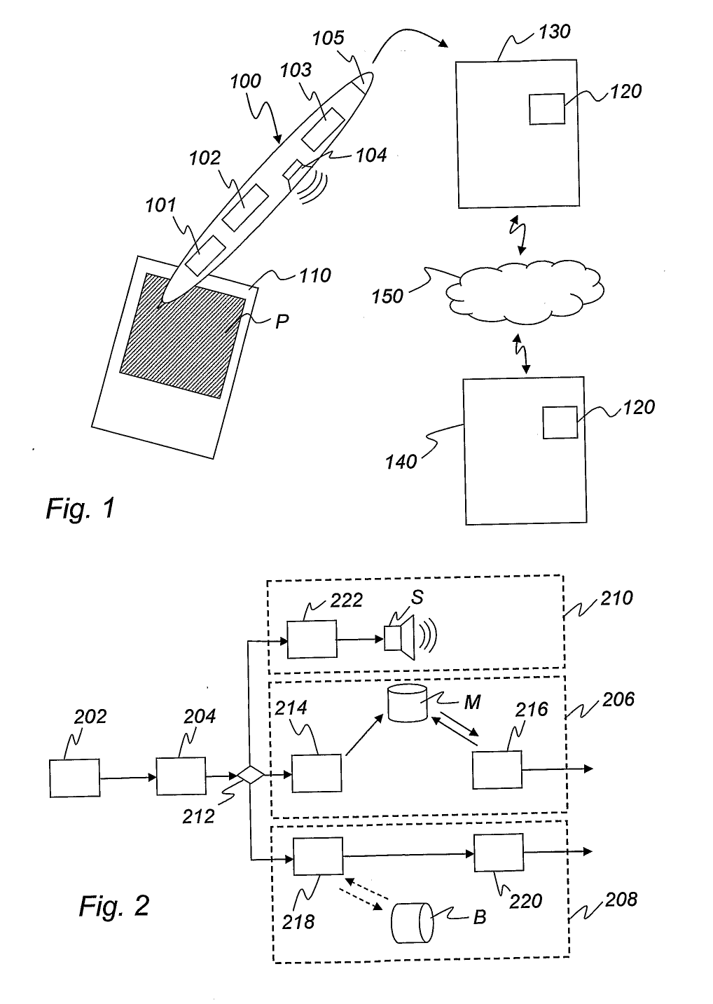

FIG. 1 illustrates an embodiment of a system for interaction with a printed product. The system includes an electronic pen 100, a product surface 110 which is provided with a coding pattern P, and an application program 120 which processes position data received from the pen 100. The pen 100 has a positioning unit 101, which generates the position data based on images of the coding pattern P on the product surface 110, a memory unit 102, a control unit 103 for controlling the pen operation, a speaker 104, and a communications interface 105 for exposing the position data to a receiving device 130. The application program 120 may be executed on the receiving device 130 or on another device 140 connected thereto, optionally via a network 150.

FIG. 2 gives a principal overview of processes in the electronic pen 100 of FIG. 1. The pen captures 202 images of the product surface. The images are processed and analyzed 204 to generate a sequence of data items, typically one position for each image. These positions are then continuously input to at least one of a store-and-send process 206, a streaming process 208, and an audio feedback process 210, based upon a switching mechanism 212.

In the store-and-send process 206, the data items are stored 214 in a persistent memory M (in memory unit 102). Then, at a later time and typically initiated by a pen user, the memory M is accessed 216 based upon a selection criterion, and resulting positions are output from the pen. The selection criterion typically indicates positions that originate from a specific part of the coding pattern. In the streaming process 208, the data items may be buffered 218 in a temporary memory B (in memory unit 102), at least while the pen 100 is connecting to the receiving device 120, before being output 220 from the pen. However, the streaming process does not include any permanent storage of the generated data items. Instead, the streaming process operates to output 220 the data items sequentially and essentially in real time with the image processing and analysis 204. The audio feedback process 210 operates to analyze 222 the data items and selectively activate the speaker S to output dedicated audio as a function of the data items received from the image processing 204. The audio process does not include storing of data items.

The store-and-send process 206 allows the pen user to create, independently of the processing application 120, a collection of pen strokes for each product P. The user can then later bring the pen to output one or more selected collections, or part of a collection, irrespective of the particular order in which the pen strokes were generated by the pen.

The streaming process 208, on the other hand, allows the data items to be output as they are generated. Thus, pen strokes may be output to the processing application 120 for processing essentially in real time. In one example, pen strokes are rendered by the application 120 to a screen, either locally for viewing by the pen user, or remotely. In another example, the application 120 provides interactive media feedback (images, video, audio, etc) to the pen user via a peripheral device, such a display or speaker, as a function of the pen strokes received by the application 120 from the pen 100.

The audio feedback process 210 is dedicated to providing audible content to the pen user. The audio feedback process 210 is preferably controlled by the data items that are generated while the pen 100 is being operated on a coded product surface 110. For example, different positions on a product may be associated with different audio content. The audio content may be designed to smarten the user experience, for example by providing different sound effects for different fields on a product, or by allowing playback of music. In other situations, the audio content may be designed to instruct, guide or help the pen user while operating the pen of the coded paper. The provision of an audio feedback process may in fact help visually impaired or even blind persons to use pen and paper.

The above processes 206, 208, 210 are suitably mutually independent. Thus, one process is not dependent on the presence of another process, so that the processes can be installed and operate individually. This modularity may facilitate the development of electronic pens, since different processes can be independently developed and tested. It will also make it possible to provide different pens with different combinations of the above processes, and to offer an upgrade option which allows a pen user, optionally for an upgrade fee, to add one of the above processes to an existing pen.

Like the audio feedback process 210, the selective activation of the store-and-send and streaming processes may be controlled by the data items that are generated when the pen 100 is operated on the product surface 110. This allows the operation of the processes to be trans-parent to the pen user. Also, it allows the developer of a product to be in control of the activation of the processes, i.e. what functionality is invoked by the product.

The switching mechanism 212 could be implemented as an upstream switching module which selectively distributes the generated data items to the individual processes and/or selectively activates the individual processes. For example, the switching module could access a lookup table which associates data items with processes. The lookup table would thus serve to register a particular process with one or more data items.

In a variant, the switching mechanism 212 is implemented in the processes themselves. Thus, the data items are continuously fed or made available to all processes, and the processes selectively activate themselves whenever they receive an appropriate data item.

In another variant, the switching mechanism 212 is distributed between an upstream module and the individual processes. Here, the upstream module issues events based on the received data items. When a process detects a specific event, it activates to operate on the generated data items.

In all of the above switching mechanisms, “selectively activate” also includes “selectively deactivate”, i.e. a process is active by default but is prevented from operating on certain data items.

The provision of the audio feedback process 210 in combination with at least one of the store-and-send process 206 and the streaming process 210 in one and the same electronic pen, results in an increased versatility of the pen. For one, the user experience may be improved, since it is now possible to implement new and very powerful ways for a pen user to generate and interact with handwritten data.

The combination of the audio feedback process 210 and the store-and-send process 206 provides to augment the user experience when documents are created with an electronic pen. For example, the user may be assisted or guided by audio content associated with a particular product or fields thereon.

The combination of the audio feedback process 210 and the streaming process 208 provides for new types of interaction with coded products. In one embodiment, the streaming output is used to create further user feedback (audible or visual) to complement the output from the audio feedback process. For example, the streaming output may be received by a local device which derives the further feedback data, e.g. over a network, and presents it to the user. In another implementation, the streaming output is processed by an external application (120 in FIG. 1) to analyze the dynamics of data entry, while the pen user is given local audio feedback from the audio feedback process. For example, the audio feedback process may be used to guide students to fill in a test form, while the streaming process may be used to provide an examiner with instantaneous data on the progress for one or more electronic pens.

The above processes may all be implemented in an electronic pen. However, it is also conceivable that all or some processes are implemented in an external device in communication with the pen. Such an external device may be a mobile phone, a PDA, a home entertainment system, a game console, a personal computer, etc. It is even conceivable that the decoding process, i.e. the generation of data items, is implemented in such an external device.

The above principles will now be described with reference to a particular embodiment, including a coding pattern, an electronic pen, and corresponding process control. It should be realized, however, that the description that follows is only intended as an example and not limiting in any way. Further variants will be briefly discussed by way of conclusion.

### Abstract Pattern

The coding pattern on the product represents a subset of a large abstract position-coding pattern. Examples of such abstract patterns are given in U.S. Pat. No. 6,570,104; U.S. Pat. No. 6,663,008 and U.S. Pat. No. 6,667,695, which are herewith incorporated by reference.

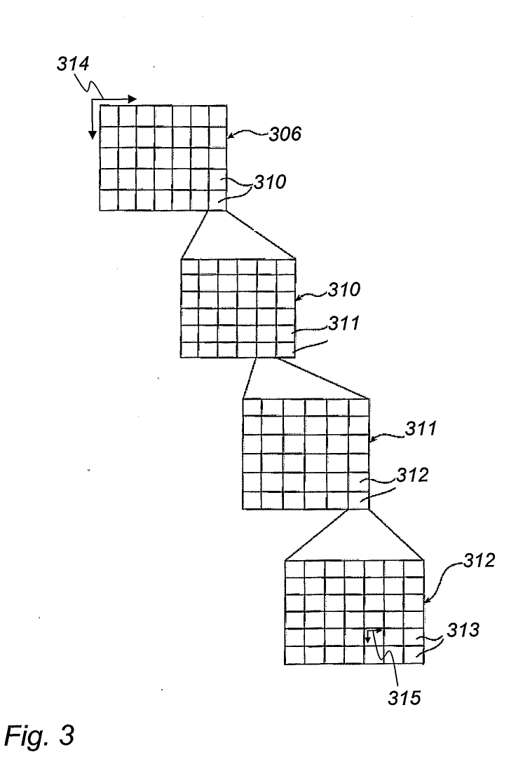

FIG. 3 shows an example, in which an abstract pattern 306 is subdivided into page units 313 which are individually addressable in a hierarchy of page unit groups 310-312. In this specific example, the abstract pattern 306 contains “segments” 310 which in turn are divided into a number of “shelves” 311, each containing a number of “books” 312 which are divided into a number of aforesaid page units 313, also called “pattern pages”. Suitably, all pattern pages have the same format within one level of the above pattern hierarchy. For example, some shelves may consist of pattern pages in A4 format, while other shelves consist of pattern pages in A5 format. The location of a certain pattern page in the abstract pattern can be noted as a page address of the form: segment.shelf.book.page, for instance 99.5000.1.1500, more or less like an IP address. For reasons of processing efficiency, the internal representation of the page address may be different, for example given as an integer of a predetermined length, e.g. 64 bits. In one example, a segment consists of more than 26,000,000 pattern pages, each with a size of about 50×50 cm².

The disclosed embodiment is also based on each product containing a coding pattern that corresponds to one or more pattern pages. It is to be noted, however, that the coding pattern on a product need not conform to a pattern page. Thus, one or more subsets from one or more pattern pages may be arbitrarily arranged on the product. The product may also have embedded functionality in that the coding pattern on the product is associated with one or more pen functions that selectively operate on electronic pen strokes that include certain positions.

The coding pattern on the product codes absolute positions. In the disclosed embodiment, each such absolute position is given as a global position in a global coordinate system 314 of the abstract pattern 306. Such a global position may be converted, with knowledge of the pattern subdivision, into a logical position, which is given by a page address and a local position in a local coordinate system 315 with a known origin on each pattern page 313.

Thus, a suitable electronic pen may record its motion on a position-coded product as either a sequence of global positions (i.e. a global pen stroke) or as a page address and a sequence of local positions on the corresponding pattern page (i.e. an addressed pen stroke).

In the disclosed embodiment, a specific page unit group in the page hierarchy (e.g. a segment, shelf, book or page) may be associated with one or more functional attributes, which thus apply for all pattern pages within that specific page unit group. One such attribute is a STREAMING attribute which indicates to the pen that recorded positions falling within a page unit group should be output in real time to an external device. A DO_NOT_STORE attribute of a page unit group causes the pen to refrain from storing recorded pen strokes falling within this page unit group.

### Electronic Pen

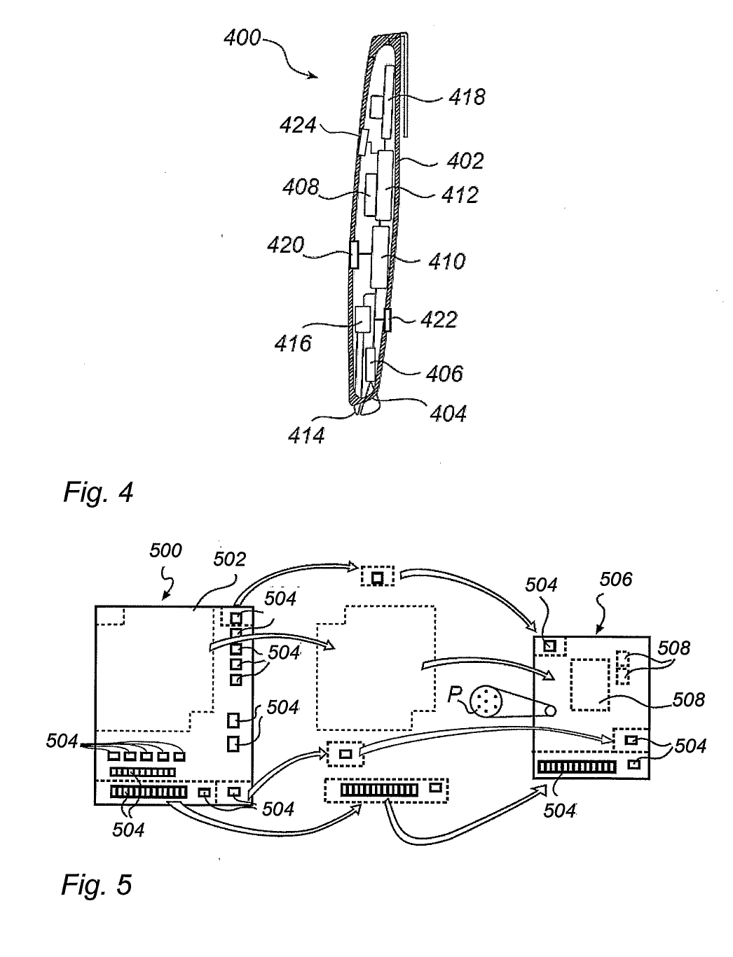

FIG. 4 illustrates an embodiment of the above-mentioned pen 400, which has a pen-shaped casing or shell 402 that defines a window or opening 404, through which images are recorded. The casing contains a camera system, an electronics system and a power supply.

The camera system 406 comprises at least one illuminating light source, a lens arrangement and an optical image reader (not shown in the Figure). The light source, suitably a light-emitting diode (LED) or laser diode, illuminates a part of the area that can be viewed through the window 404, by means of infrared radiation. An image of the viewed area is projected on the image reader by means of the lens arrangement. The image reader may be a two-dimensional CCD or CMOS detector which is triggered to capture images at a fixed or variable rate, typically of about 70-100 Hz.

The power supply for the pen is advantageously a battery 408, which alternatively can be replaced by or supplemented by mains power (not shown).

The electronics system comprises a control unit 410 which is connected to a memory block 412. The control unit 410 is responsible for the different functions in the electronic pen and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 412 comprises preferably different types of memory, such as a working memory (e.g. a RAM) and a program code and persistent storage memory (a non-volatile memory, e.g. flash memory). Associated software is stored in the memory block 412 and is executed by the control unit 410 in order to provide a pen control system for the operation of the electronic pen.

The casing 402 also carries a pen point 414 which may allow the user to write or draw physically on a surface by a pigment-based marking ink being deposited thereon. The marking ink in the pen point 414 is suitably transparent to the illuminating radiation in order to avoid interference with the opto-electronic detection in the electronic pen. A contact sensor 416 is operatively connected to the pen point 414 to detect when the pen is applied to (pen down) and/or lifted from (pen up) a surface, and optionally to allow for determination of the application force. Based on the output of the contact sensor 416, the camera system 406 is controlled to capture images between a pen down and a pen up. These images are processed by the control unit 410 to generate a sequence of positions that represent the absolute location and movement of the pen on a coded product.

The generated positions can be output by the pen, via a built-in communications interface 418 for external communication, to a nearby or remote apparatus such as a computer, mobile telephone, PDA, network server, etc. To this end, the external interface 418 may provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network.

The pen may also include an MMI (Man Machine Interface) 420 which is selectively activated for user feedback. The MMI includes at least a speaker, but may also comprise a display, an indicator lamp, a vibrator, etc.

Still further, the pen may include one or more buttons 422 by means of which it can be activated and/or controlled, and/or a microphone 424 for picking up sound waves, e.g. speech in the surroundings of the pen.

### Pen Control System

The pen 400 operates by software being executed in the control unit 410 (FIG. 4). The pen system software is based on modules. A module is a separate entity in the software with a clean interface. The module is either active, by containing at least one process, or passive, by not containing any processes. The module may have a function interface, which executes function calls, or a message interface, which receives messages. The active and passive modules are basically structured as a tree where the parent to a module is responsible for starting and shutting down all its children.

The pen system software also implements an event framework to reduce dependencies between modules. Each module may expose a predefined set of events that it can signal. To get a notification of a particular event, a module must be registered for this event in an event register. The event register may also indicate whether notification is to take place by posting of a message, or as a callback function.

The operation of the pen is at least partly controlled by the user manipulating the pen on a specific part of the abstract position-coding pattern. The pen stores one or more templates that define the size, placement and function of functional areas within a specific set of pattern pages. The functional areas, denoted as “pidgets”, are associated with functions that affect the operation of the pen. A pidget may, i.a., indicate a trigger function which triggers the pen to expose data, as will be further explained below.

FIG. 5 further illustrates the interrelation between pattern page 502, template 500 and tangible product 506. The pattern P on the product 506 defines positions within one or more pattern pages 502 (only one shown in FIG. 5). The pen stores a template 500 that may define one or more pidgets 504 on the pattern page(s) 502. Whenever the pen is put down on a coded part of the product, it records a position and is able to correlate this position to the relevant template and identify any function associated with the position. It is to be noted that although pidgets 504 have a predefined placement and size within the pattern page 502, they may have any placement on the product 506. Thus, parts of the pattern page may be “cut out” and re-assembled in any fashion on the product, as shown by the dashed sections in the middle of FIG. 5.

The product 506 may also contain audio-enabled fields 508 that are used by the audio feedback process which associates audio programs, denoted as “paplets”, with the positions within these input fields. These audio-enabled fields may or may not be defined in the templates.

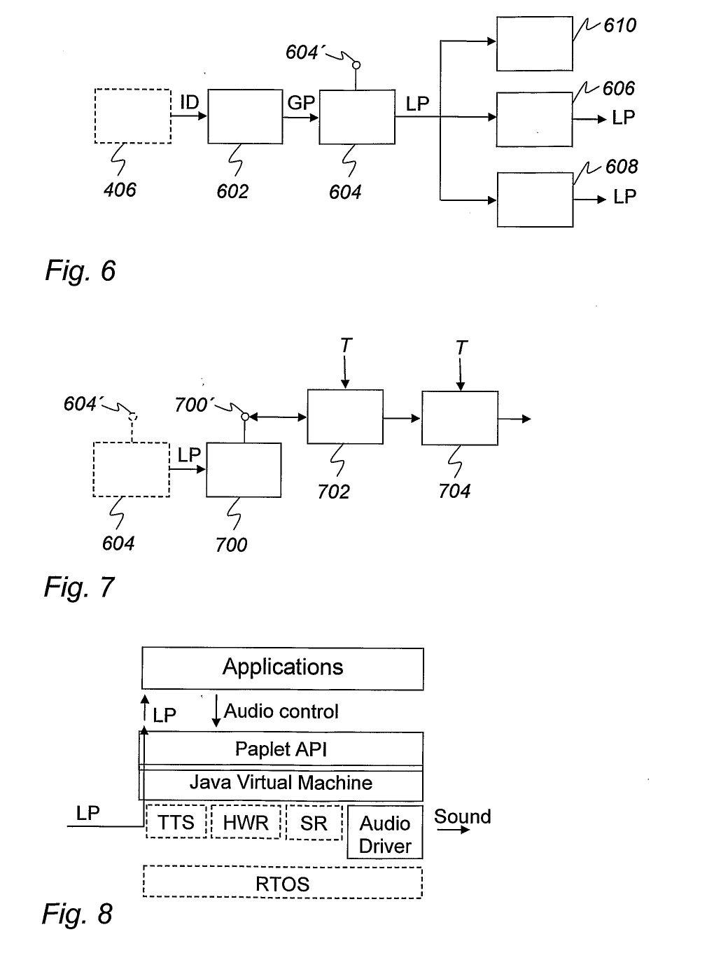

FIG. 6 illustrates a number of software modules in the pen control system. An Image Processing module 602 receives image data (ID) from the camera system (406 in FIG. 4) and feeds a sequence of global positions (GP) to a Translator module 604 which converts these global positions to logical positions (LP). The Translator module 604 also checks if the positions are associated with any attribute or template, and also maps the positions against the template. If a stroke is detected to pass through a pidget, the Translator module 604 generates a corresponding pidget event. The Translator module also has an interface 604′ allowing other modules to derive information about templates, functional attributes and pidgets.

The Translator module 604 normally feeds all logical positions to an S&S module 606 which implements the send-and-store process, a Streamer module 608 which implements the streaming process, and an Audio module 610 which implements the audio feedback process.

Whenever the Translator module 604 detects a DO_NOT_STORE attribute, it stops feeding the associated logical positions to the S&S module 606.

The Streamer module 608 continuously accesses the interface 604′ to check whether any received logical position is associated with a STREAMING attribute. On detection of such an attribute, the Streamer module 608 starts to sequentially output the relevant logical positions (LP).

The Audio module 610 continuously maps the received logical positions against an application register that associates areas (typically pattern pages) with audio programs (paplets). Whenever the page address of a logical position matches a paplet in the application register, the Audio module 610 initiates execution of this paplet.

Thus, in this particular embodiment, the pen may be selectively activated to execute the send-and-store process (by default), the streaming process (if the imaged pattern is associated with both a STREAMING attribute and a DO_NOT_STORE attribute) or both of these processes (if the imaged pattern is associated with a STREAMING attribute, but not a DO_NOT_STORE attribute). Concurrently, the pen may be selectively activated to execute the audio feedback process (if the imaged pattern is associated with a paplet in the application register).

In the above embodiment, the above processes operate on a common runtime system which includes a pen operating system, a hardware abstraction layer, drivers, communication protocols, image processing and coordinate translation. Since coordinate translation is part of the common runtime system, the above processes may all use the same pattern subdivision and addressing.

### Store-and-Send Process

The store-and-send process generally operates to store recorded positions as pen strokes in the pen's memory block (412 in FIG. 4) and/or store the result of any dedicated processing of these pen strokes. The store-and-send process also allows the pen to selectively retrieve pen stroke data from its memory block and expose this data to external devices via its interface for external communication (418 in FIG. 4).

The process of exposing pen strokes involves spatially collating the pen strokes stored in the memory block. Typically, pen stroke data is collated by page address. The resulting collated data may include pen stroke data from one or more specific pattern pages. Generally, the collated data does not represent the chronological order in which pen strokes were recorded by the pen, but is rather a collection of all pen stroke data recorded on a particular part of the position-coding pattern. Within the collated data, the pen stroke data may or may not be arranged chronologically for each pattern page.

The user may trigger the pen to retrieve, collate and expose pen strokes by interacting with the coded product surface. In one such embodiment, the pen is triggered by detection of a dedicated pidget, e.g. the above-mentioned trigger pidget. The selection of strokes to be retrieved may also be indicated by the trigger pidget, or by another content pidget detected in conjunction with the trigger pidget. In one example, the content pidget or the trigger pidget explicitly indicates one or more individual page units or a page unit group (segment, shelf, book). In another example, the pen retrieves strokes belonging to the same page unit/page unit group as the content/trigger pidget, or belonging to the page unit/page unit group which is associated with the template that includes the content/trigger pidget.

Clearly, there are alternative ways to trigger the pen. For example, exposure may be triggered by the user pressing a button on the pen, by the user issuing a verbal command to be recorded by a microphone in the pen, by the user making a predetermined gesture with the pen on the coded product surface, by the user connecting the pen to the receiving device. Clearly, there are also alternative ways of selecting strokes. For example, strokes may be selected from within a bounding area defined by dedicated pen strokes (i.e. the pen is moved on the product to indicate to the pen what to expose), or strokes may be selected from all pattern pages associated with a particular attribute, or all strokes in the pen memory may be automatically selected for exposure, or the selection of strokes may be given by instructions received from the receiving device (130, 140 in FIG. 1) on the pen's external communications interface.

In one embodiment, the collated data is incorporated in a file object. The pen stroke data in the file object is self-supporting or autonomous, i.e. the application program (120 in FIG. 1) is able to access and process the data without any need for communication with the pen that created the data. Further aspects, implementations and variants of the file object and its associated one-way data transport protocol is described in WO2006/004505, which is herewith incorporated by reference.

In another embodiment, the pen establishes an end-to-end communication with the application program, and outputs the collated data as part of an http request to the receiving device. A protocol for such communication is further disclosed in Applicant's patent publication US 2003/0055865, which is herewith incorporated by reference.

FIG. 7 illustrates an embodiment of the S&S module in FIG. 6 in some more detail. Here, the S&S module comprises three sub-modules: a Coordinate Manager module 700, a Collation module 702, and an Exposure module 704.

The Coordinate Manager module 700 receives the logical positions from the Translator module (604 in FIG. 6). Before storage, it groups the logical positions into temporally coherent sequences, i.e. strokes. The Coordinate Manager module 700 may then preprocess each stroke for compression and store the result in non-volatile memory. Examples of such compression and storage are given in US 2003/0123745 and US 2003/0122802.

The Coordinate Manager module 700 also contains an interface 700′ for other modules to search for stored strokes, e.g. based on page address, and to retrieve strokes in a transport format. In one embodiment, the transport format is binary and includes the following data: a start time for each stroke, local positions in each stroke, and a force value for each position.

The Collation module 702 is implemented to generate the collated data to be exposed to data handlers outside the pen. The module 702 is implemented to listen for a dedicated trigger event (T), such as a trigger event issued by the Translator module when detecting a trigger pidget. The trigger event then causes the Collation module 702 to retrieve a specific set of pen strokes via the interface 700′.

The Exposure module 704 provides the collated data to data handlers outside the pen. The module is implemented to listen for a dedicated trigger event (T), such as the trigger pidget event. The trigger event causes the Exposure module 704 to expose the data collated by the Collation module 702, e.g. according to either of the above-mentioned protocols.

### Audio Feedback Process

The audio feedback process generally operates to provide audible content to the user in real time with the generation of position data.

The Audio module allows for an audio program (paplet) to be installed in the pen. A paplet is a small piece of software assigned to a specific pattern area, typically one or more pattern pages, and designed to receive position data recorded on this pattern area in real-time and to give audio feedback in response thereto.

FIG. 8 illustrates a system architecture including an implementation of the audio feedback process. The architecture comprises a Java Virtual Machine, core classes and supporting Java platform libraries, as well as a custom Java Paplet API, on top of the pen operating system (RTOS). In one embodiment, the core classes are based on CLDC (Connected Limited Device Configuration) which is a framework with a base set of classes and APIs for J2ME applications.

Thus, the Audio module is formed in a Java-based runtime system optimized for embedded systems with limited memory and processing power. Paplets are programs written in Java language to be run in real time by the Audio module. The paplets uses the functions of the Paplet API to access the audio capabilities of the pen. The Audio module also includes one or more audio drivers, and may also include an interface to a hand-writing recognition (HWR) module, a text-to-speech synthesis (TTS) module and/or a sound recording (SR) module, which all may be implemented by software, hardware or a combination thereof. The HWR module may be called by the Audio module or the S&S module to convert handwriting formed by strokes into computer text. The resulting computer text may then be used by the calling module. The TTS module may be called by the Audio module to create an audio file with a spoken version of handwriting or computer text. The SR module may be called by the Audio module or the S&S module to record, via the pen's microphone (424 in FIG. 4), an audio track which may be time stamped in the same time reference as the position data. The resulting audio file may then be output via the S&S module, or used within the Audio module, as will be further explained below.

Paplets are distributed in paplet package files which may include the paplet, audio resources, as well as area definition data and content definition data. The paplet is distributed as a Java class file. The audio resources comprise one or more audio files in a compressed or uncompressed format (e.g. AAC, MP3, MIDI, etc) supported by audio drivers in the pen. The area definition data specifies the location of all relevant areas on one or more pattern pages associated with the paplet. The content definition data identifies the audio file associated with each audio-enabled field. The area definition data and/or content definition data may be included as Java code in the class file, but may alternatively be included in one or more separate files which can be installed in the pen to be accessed by the Audio module when running the paplet. In one embodiment, this data is incorporated in or stored as a template in pen memory.

The paplet package files may be made accessible to the Audio module in variety of different ways. A paplet package file may be imported via the external communications interface of the pen. In one embodiment, the pen may download a paplet package file from a local device (computer, mobile phone, etc) or a dedicated network server. In another embodiment, the pen is connected to a local device which is operated to upload a paplet package file to pen memory, e.g. via an ftp server in the pen. In yet another embodiment, the paplet package file may be provided on a memory unit which is removably installed in or connected to the pen to be accessed by the Audio module. The memory unit may be in the form of a card or a cartridge of any known type, such as SD card, CF card, SmartMedia card, MMC, Memory Stick, etc. In another alternative, the paplet package file is encoded as a graphical code on the product, and the pen is capable of inferring the paplet package file from the recorded images. Thus, the paplet package file is imported by the pen user operating the pen to read the code off the product. Many large-capacity codes are available for such coding, such as two-dimensional bar codes or matrix codes. Further examples of suitable codes, and methods for their decoding, are given in Applicant's prior publications: US 2001/0038349 US 2002/0000981, and WO 2006/001769.

In one embodiment, the paplet package file is implemented as a jar file (Java Archive). This reduces the risk of identically named audio files colliding between running paplets, since audio files of different jar files will be automatically stored as different files in pen memory.

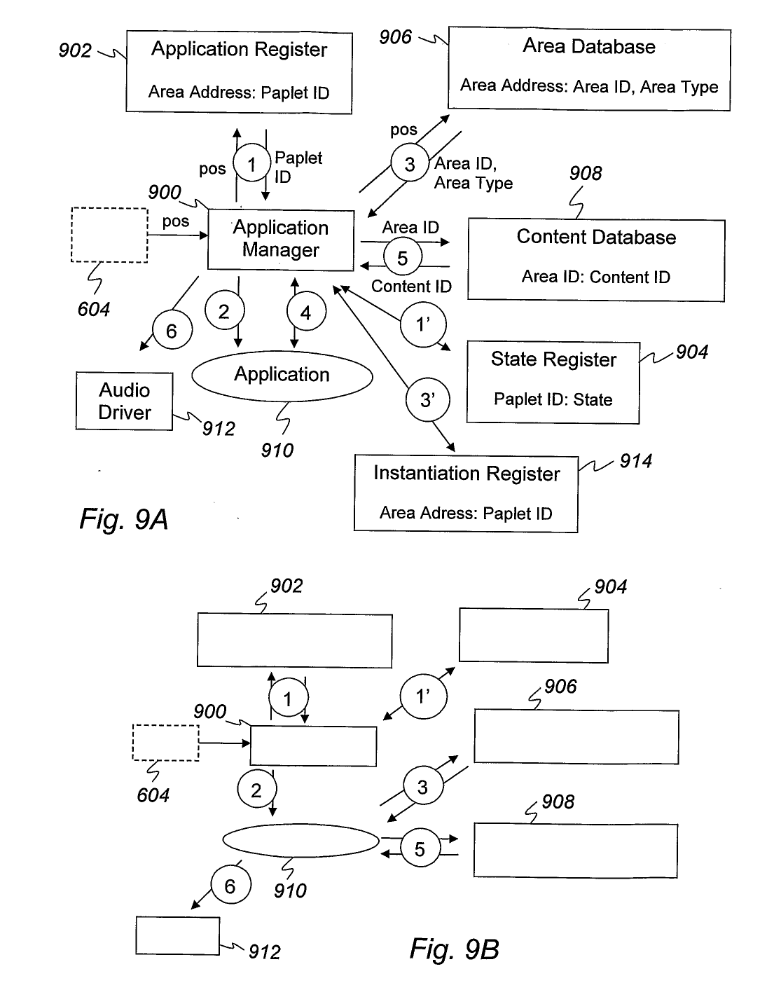

FIG. 9A shows further details of one embodiment of the Audio module. Here, the Audio module comprises an Application Manager 900 which handles paplet initiation and shut-down based on the logical positions received from the Translator module (604 in FIG. 6), as well as executes basic-operations on behalf of the running paplets. Applications communicate with the Application Manager 900 via the above-mentioned Java Paplet API. The Audio module further comprises an Application Register 902 which associates area addresses with paplets, a State Register 904 which stores state information of running paplets, an Area Database 906 which represents the area definition data for the paplet currently run by the Audio module, and a Content Database 908 which represents the content definition data for the paplet currently run by the Audio module.

When a paplet is installed in the pen, an entry is added to the Application Register 902 to associate the paplet, via a paplet ID, with a particular area address. Any suitable identifier may be used as paplet ID, such as a unique number, the paplet name (Java class name), the jar file name, etc. The area address may indicate one or more pattern pages or a subset thereof, for example a polygonal area defined in local positions on a particular pattern page. The entry may be made automatically by the Application Manager 900 deriving adequate data from the paplet package file, or by a user accessing the Application Register 902 in the pen memory via the pen's external communications interface to manually enter the association, for example via a browser.

The Application Manager 900 continuously maps the received logical positions against the Application Register 902 (step 1). Whenever a logical position falls within a registered area address, the corresponding paplet is launched to control the interaction between the user and the product (step 2). Recalling that the paplet is a class file, launching the paplet involves locating and instantiating the class file to create an object, which forms a running application 910. In this particular embodiment, only one application can run at a time.

When a paplet is launched by the Application Manager 900, the corresponding area definition data is loaded into the Area Database 906, in which each entry defines the location of a relevant area in local positions, an area ID, and an area type (Type1, Type2, or both). Type1 indicates that the running paplet should be notified when a stroke enters and exits the area, respectively. Type2 indicates that the running paplet should be notified of all positions recorded within the area. Similarly, the corresponding content definition data is loaded into the Content Database 908, in which each entry associates an area ID with content. The content may be an audio file installed together with the paplet, or an audio file included in a set of universal audio files which are pre-stored in pen memory to be accessible to all paplets. Such universal audio files may represent frequently used feedback sounds, such as numbers, letters, error messages, startup sounds, etc.

The Application Manager 900 continuously maps the received logical positions against the Area Database 906 (step 3). Whenever a logical position falls within an area registered in the Area Database 906, the Application Manager 900 generates an area event, which includes the area ID and an “enter”-indication, an “exit”-indication or a position, depending on area type. The area event is made available to the running application 910, which may decide to issue a feedback event (step 4). The feedback event causes the Application Manager 900 to identify the appropriate audio file from the Content Database 908 (step 5), and bring the audio driver 912 to play the audio file for output via the speaker (step 6).

In order to allow the Application Manager 900 to start and stop the applications and to let the running applications 910 retrieve events, the paplets may extend a Java Paplet class which defines basic entry points for starting and stopping applications, saving states, restoring states, etc, and/or the paplets may implement a Java Paplet interface which defines names of such basic entry points.

The Audio module may also allow the Content Database 908 to be amended in run-time, for example by deleting existing entries, by adding new entries, or by adding new content to existing entries. Such new content may be dynamically created while the application is running. It could include an audio file that is associated with another area, a universal audio file, an audio file generated by the sound recording (SR) module (FIG. 8), one or more strokes recorded within a particular area, the output of HWR processing of such stroke(s), or the result of TTS processing of such HWR output. Thus, the running application 910 could cause the Application Manager 900 to store a reference to such new content in the Content Database 908, and later access the Content Database 908 to retrieve this content for processing and/or output.

The Audio Module may also allow the Area Database 906 to be amended in run-time, for example by deleting existing entries or adding new entries. New areas could be dynamically created while the application is running, e.g. given by recorded stroke(s). In one such example, the running application 910 guides the user, e.g. via audio commands, to populate the Area Database by drawing on the coded product surface, to thereby dynamically create a user interface thereon. The user may then interact further with the application 910 via the user interface. Thus, the running application 910 could cause the Application Manager 900 to add an entry to the Area Database 906, including an area location given by the recorded stroke(s), a unique area ID, and a desired area type. The running application will then be notified of any position that falls within this area and take appropriate action. Similarly, existing entries in the Area Database 906 could be changed in run-time, for example with respect to area location or area type.

Below follows a brief example of a paplet capable of amending the Area and Content Databases 906, 908. The paplet is designed to provide a pen with the ability to associate audio picked up by the pen's microphone (424 in FIG. 4) with positions decoded from a coded product. The positions may be generated by the user manipulating the pen on the coded product (writing, pointing, etc). The paplet may then allow a pen user to access the recorded audio by again manipulating the pen on the coded product.

This exemplifying paplet may initiate an audio recording session in which it accesses the SR module (FIG. 8) to record audio picked up by the microphone (424 in FIG. 4). During the audio recording session, the paplet may process incoming positions to identify replay areas, according to predetermined rules (see below), and to add such replay areas to the Area Database 906. The added replay area may be associated with an audio snippet, i.e. a relevant part of the recorded audio, by the paplet adding an entry to the Content Database 908 that associates the area ID of the added replay area with an identifier of the audio snippet. The audio snippets may be stored as separate audio files in pen memory, or they may be given by references (e.g. a time interval) to an overall audio file stored in pen memory.

The aforesaid replay area may be defined by a pre-determined zone around each recorded position, stroke, word, line of words or paragraph written with the pen on the coded product. The zone may be a bounding box around a stroke/word/line/paragraph, or it may have a fixed extent. Alternatively, the paplet can identify a replay area for each position/stroke/word/line/paragraph based on a predetermined partitioning of a pattern page into replay areas. The definition and use of replay areas is further described in Applicant's U.S. Provisional Application No. 60/810,178, filed on Jun. 2, 2006 and incorporated herein by this reference.

The exemplifying paplet may also be configured to initiate an audio replay session, in which the paplet causes the Audio module to identify audio snippets associated with incoming positions, via the populated Area and Content databases, and to bring an audio driver (912 in FIG. 9) to play these snippets for output on the pen's speaker.

The exemplifying paplet may also be configured to output an audio session via the pen's external communications interface. Such an audio session may comprise not only the recorded audio snippets, but also the populated Area and Content Databases, and optionally the paplet. The audio session may be imported into another device, which may execute an audio replay session based thereon.

Returning now to the embodiment in FIG. 9A, the running application 910 always has a “state” which includes the above-mentioned definition data that defines the location of relevant areas and associates at least part of these areas with content. As described above, such areas and/or content could be predefined to the application or be dynamically created while the application is running. Whenever the Application Manager 900 is triggered by positions from the Translator module to launch a new paplet, and thus needs to shut down the running application (object), the object and its state can be saved for later retrieval. When a state is saved, an entry is also created in the State Register 904 to associate the object with the state. Before launching a paplet, the Application Manager 900 may check if the corresponding object is already listed in the State Register (step 1′). If so, the Application Manager 900 may load the object and its state to re-activate the previously running application (step 2). If a running application is shut down preemptively, the Application Manager 900 could be caused to select another application for re-activation by processing the entries of the State Register 904 according to pre-defined logic, e.g. Last-In-First-Out.

It is to be understood that different applications could be designed to be handled in different ways. Thus, some applications may be stored and referenced in the State Register 904, whereas others may be shut down preemptively.

In case the State Register 904 gets full, entries could be deleted in accordance with any suitable logic. For example, using a FIFO (First-In-First-Out) logic, the oldest entry would be deleted to make room for a new entry. Possibly, such logic could be modified based on application activation frequency, such that applications that have been re-activated more often are kept longer in the State Register.

The runtime system may also implement a garbage collection process to intermittently cleanse the memory of objects and states that are no longer listed in the State Register 904.

The above functionality enables a user to apply the pen to a product P1, thereby causing the Audio module to launch an application A1. The user interacts with P1/A1 for a while, and then applies the pen to product P2. This causes the Audio module to intermittently shut down A1 and instead launch application A2. After having interacted with P2/A2, the user again applies the pen to P1. This causes the Audio module to re-activate A1, and to the extent necessary for the interaction process, A1 is aware about actions previously taken by the user on P1.

The embodiment of FIG. 9A may be modified to allow more than one application to be run at a time. In one such variant, the State Register is complemented or replaced by an Instantiation Register 914 which associates area addresses with running applications, e.g. via aforesaid paplet IDs. Thus, the Application Manager accesses the Instantiation Register 914 to identify the application(s) associated with the incoming logical position (step 3′), and includes the paplet ID(s) in the area event to be issued (step 4). The running applications then use the paplet ID(s) in the area event to determine the relevance of the area event. In this variant, the definition data of all running applications is included in the Area and Content Databases 906, 908. This multi-application variant may also allow multiple instances of one and the same paplet to run simultaneously, if these instances are distinguishable in the Instantiation Register 914 and/or State Register 904.

FIG. 9B shows another embodiment of the Audio module, where like elements have the same reference numerals as in FIG. 9A. One difference over the embodiment in FIG. 9A is that each application 910 directly accesses the Area Database 906 (step 3) and the Content Database 908 (step 5), and controls the audio driver 912 (step 6), whereas the Application Manager 900 handles only paplet initiation and shut-down (steps 1 and 1′). Event notification between Application Manager 900 and application 910 can thus be omitted.

In all of the above variants, the Application Register 900 is populated by predetermined associations between area addresses and installed paplets. However, it is also conceivable that a paplet is installed in the pen without being associated to a particular area address. In one such variant, the Application Manager 910 is caused to instantiate the paplet on receipt of a dedicated external event, e.g. caused by the user pressing a button on the pen, by the user issuing a dedicated verbal command recorded by the microphone, or by the user making a dedicated gesture with the pen on the coded product surface. The running application could then guide the user, e.g. via audio commands, to populate the Area Database 906 by drawing on the coded product surface, to thereby dynamically create a user interface thereon. Also the Content Database 908 may be thus populated, and the State Register 904 may be updated accordingly. The user may then interact further with the application via the user interface. To this end, the Instantiation Register 914 may be updated to store an association between the running application and an area address representative of the thus-created user interface.

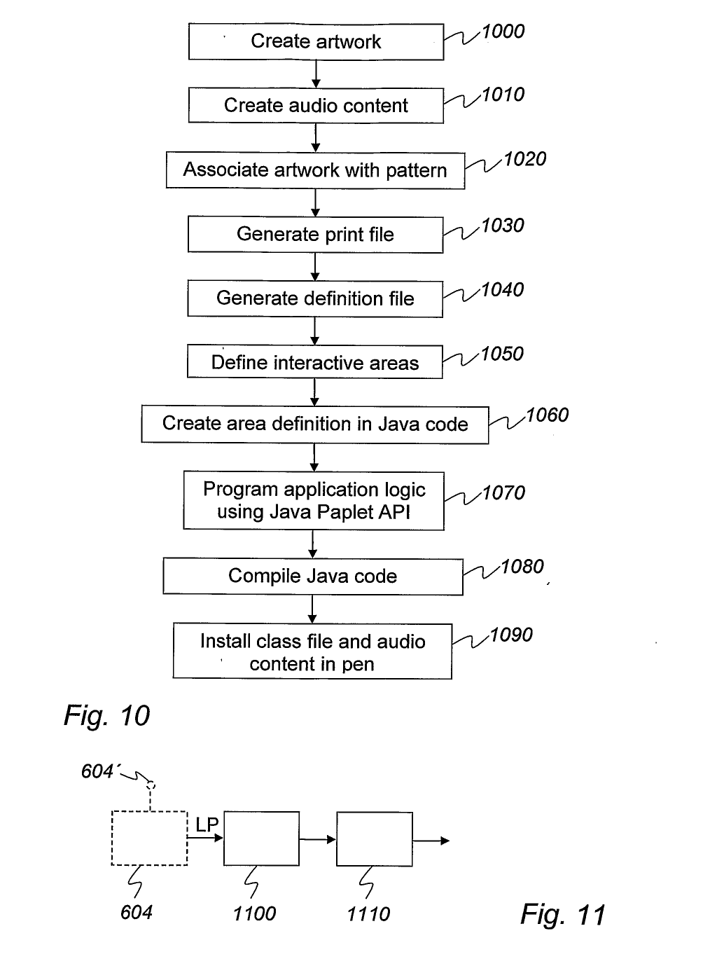

FIG. 10 is a flowchart illustrating an exemplifying process for developing and installing a paplet. In step 1000, the artwork for the product is created using any conventional program for drawing, graphical design or text editing, and saved as an artwork file. In step 1010, audio content in the form of one or more audio files is created using any suitable audio recording program. In step 1020, the artwork file is imported into a Pattern Association Tool in which it is associated with one or more pattern pages. The association may be made either automatically or under control of the product/paplet designer. In step 1030, the Pattern Association Tool is operated by the designer to generate a print file which allows the artwork to be printed together with the relevant coding pattern of the pattern page on a digital printer/press or an offset printing process. In step 1040, the Pattern Association Tool is operated by the designer to generate a definition file which identifies the associated pattern page(s), and the arrangement of the pattern page(s) on the physical page. In step 1050, the artwork file and the definition file are imported into an Area Definition Tool which allows the application designer to define interactive areas on the physical page, using a polygon drawing tool. In step 1060, the Area Definition Tool is operated by the designer to create an area definition in Java code, in which all interactive areas are enumerated and given a placement in local positions on the relevant pattern page. In step 1070, the designer programs the application logic in any Java IDE, e.g. UltraEdit, and using the Java Paplet API to provide audio feedback and position interaction. Also in this step, the Java-coded area definition is incorporated into the application code, together with the appropriate associations between interactive areas and audio files. In step 1080, the Java source code is compiled to Java bytecode, and suitably subjected to testing and verification before being installed in the pen. Finally, in step 1090, the resulting class file, which forms the paplet, and the audio files are installed in the pen, e.g. by the paplet being associated with the proper page addresses) in the Application Register.

In this particular embodiment, the area and content definition data are thus included as Java code in the paplet. As mentioned further above, the area and/or content definition data may instead be included as one or more separate files in a paplet package for installation in the pen.

### Streaming Process

The streaming process generally operates to stream recorded position data to the receiving device in real time or near real time with its generation.

FIG. 11 illustrates an embodiment of the Streamer module in FIG. 6 in some more detail. Here, the Streamer module comprises two sub-modules: a Coordinate Feed module 1100 and an Exposure module 1110.

As indicated above, the Coordinate Feed module 1100 continuously accesses the Translator module interface 604′ to check whether any received logical position is associated with a STREAMING attribute. On detection of such an attribute, the Coordinate Feed module 1100 causes the Exposure module 1110 to output the relevant logical positions.

The Coordinate Feed module 1100 has three internal states: Disconnected, Connecting, and Connected. It enters the respective state based on events generated by the Exposure module 1110, as will be described below.

In the Disconnected state, the Coordinate Feed module 1100 accesses the Translator module interface 604′ to check if any received position is associated with a STREAMING attribute. Upon detection of such an attribute, the Coordinate Feed module 1100 triggers the Exposure module 1110 to establish a connection to the receiving device (130 in FIG. 1). The Coordinate Feed module 1100 then enters the Connecting state and starts to sequentially store all logical positions (together with force value and timestamp) output by the Translator module 604 in a buffer memory (typically RAM) included in the memory block (412 in FIG. 4). The duration of the Connecting state is typically about 1-10 seconds.

When the Exposure module 1110 has established a connection to the receiving device, it issues a Connected event. When the Coordinate Feed module 1100 detects the Connected event, it enters the Connected state and generates data according to a predetermined streaming format. In one embodiment, this format includes three different messages: NewSession(timestamp, pen identifier); NewPosition(timestamp, page address, position, force value); PenUp(timestamp).

The NewSession message is generated upon detection of the Connected event, with the timestamp reflecting the time when connection is established. NewPosition messages are generated to each include one logical position, a force value and a time value. The NewPosition messages may also include orientation data which is derived from the captured images to indicate the three-dimensional orientation of the pen during the recording of positions. The time value reflects the time when the originating image was captured by the pen camera system. Whenever the pen is moved out of contact with the writing surface, as indicated by the contact sensor (416 in FIG. 4), the Coordinate Feed module 1100 generates the PenUp message.

In an alternative embodiment, the page address is output only once for each pen stroke. To further reduce the amount of data to be transferred, local positions may be eliminated from each pen stroke according to a resampling criterion and/or each local position may be given as a difference value to a preceding local position in the same stroke, for example as described in aforesaid US 2003/0123745 and US 2003/0122802.

The Coordinate Feed module 1100 always processes the logical positions in the order they were generated by the Image Processing module (602 in FIG. 6). Thus, it first retrieves and processes the positions that were stored in the buffer memory during the Connecting state, and then processes the subsequently generated positions, if necessary via intermediate storage in the buffer memory.

If the Coordinate Feed module 1100 is instructed to stop streaming, it will remain in the Connected state until it has processed all data in the buffer memory, thereby causing the Exposure module 1110 to output this data.

If the Exposure module 1110 fails to establish a connection, it issues a Connection Failure event. If this event is received by the Coordinate Feed module 1110 while in the Connecting state, the Coordinate Feed module 1110 operates to delete all data from the buffer memory.

The streaming format allows the receiving device to distinguish between data generated during the Connecting state and the Connected states, respectively. The timestamps of positions recorded during the Connecting state will precede the timestamp of the NewSession message, whereas timestamps of positions recorded during the Connected state will succeed the NewSession message timestamp. Alternatively or additionally, a bit value may be included in each NewPosition message to indicate whether its data has been buffered or not.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the coding pattern on the product surface may directly encode a logical position. Such a coding pattern is disclosed in U.S. Pat. No. 6,330,976 to tile coding cells over the product surface, each cell coding both a local position and a page identifier. The pen is thus capable of directly inferring its logical position from the coding pattern on the product.

In another variant, the coding pattern not only encodes positions, but also encodes flag bits that are indicative of functional attributes and/or are used to selectively activate one or more of the above-mentioned processes.

Further, the store-and-send, streaming and audio modules may be distributed between the electronic pen and the receiving device. Also, the system for interacting with a coded product surface may include the audio module, and one of the store-and-send module and the streaming module.

The different processes in the pen may be implemented by software, by hardware or by a combination thereof.

It should also be noted that the pen may include complementary equipment for relative positioning, such as accelerometer, roller ball, triangulation device, etc. Thus, the pen may supplement the absolute positions derived from the coding pattern with the relative positions given by the complementary equipment. In this case, the coding pattern need only code few absolute positions on the product surface.

The described embodiments of the audio process/system/module may include features that provide distinct advantages without also being connected to the provision of a store-and-send process or a streaming process. Such features include, but are not limited to, the disclosed concept, functionality, operation and structure of any one of a Paplet, a Paplet package, an Application Manager, an Area Database, a Content Database, an Application Register, a State register, and an Instantiation Register, and combinations thereof.

1-29. (canceled)

30. A system for interacting with position data representing pen movement on a product provided with a position-coding pattern, comprising:
a position storage module which is operable to store the position data in a persistent-storage memory; and
an audio module which is operable to correlate the position data with audio data and to provide the audio data for output on a speaker device;
wherein operation of at least one the position storage module and the audio feedback module is selectively activated as a function of the position data.

31. The system of claim 30, wherein the position storage module and the audio module operate independently.

32. The system of claim 30, wherein at least one of the modules is selectively activated by it receiving the position data.

33. The system of claim 30, wherein at least one of the modules selectively activates when the position data matches an activation criterion.

34. The system of claim 30, wherein the audio module provides for installing dedicated audio feedback programs and selectively associating each audio feedback program with a set of position data.

35. The system of claim 34, wherein activating the audio module includes executing one of said audio feedback programs.

36. The system of claim 34, wherein the audio module associates each audio feedback program with a unique set of position data.

37. The system of claims 34, wherein each audio feedback program is associated with definition data that defines at least one interactive region within said unique set of position data.

38. The system of claim 37, wherein the interactive region is predefined to the audio feedback program.

39. The system of claim 37, wherein the interactive region is derived from position data received during execution of the audio feedback program.

40. The system of claim 37, wherein the definition data further comprises a unique identifier of each interactive region.

41. The system of claim 37, wherein the definition data further comprises a type value of said at least one interactive region, the type value indicating to the audio module whether the audio feedback program is to be provided with the received position data that fall within the interactive region, or the audio feedback program is to be provided with an indication that the received position data fall within the interactive region, or both.

42. The system of claim 37, wherein the definition data further indicates audio content associated with said at least one interactive region.

43. The system of claim 42, wherein the audio content refers to at least one of: a pre-stored audio file that is universally available to audio feedback programs, an audio file that is uniquely associated with the audio feedback program, or an audio file that is created during execution of the audio feedback program.

44. The system of claim 34, wherein the audio feedback program is a Java class file, and said audio module comprises a Java Virtual Machine.

45. The system of claim 44, wherein said Java class file and said audio content is provided to said audio module as incorporated in a JAR file.

46. The system of claim 34, wherein the audio module is operable to hold a state list which identifies previously executed audio feedback programs and state information for each such audio feedback program.

47. The system of claim 30, wherein the position storage module is operable to selectively derive the position data from the persistent-storage memory for output on a communications interface.

48. The system of claim 30, wherein the position storage module is operable to collate the position data to represent individual pen strokes.

49. The system of claim 48, wherein each pen stroke is associated with a position area identifier indicative of a position area defined in a global coordinate system given by said position-coding pattern, and wherein the position storage module is operable to the selectively derive the position data collated by position area identifier.

50. The system of claim 30, wherein the position storage module and the audio module are included in a common device.

51. The system of claim 50, wherein the common device is one of: a pen device which is operated to read said position-coding pattern, a mobile phone, a personal computer, a home entertainment system, a PDA, and a game console.

52. The system of claim 30, wherein one of said modules is included in a pen device which is operated to read said position-coding pattern, and another of said modules is included in a separate computer device.

53. A method of interacting with position data representing pen movement on a product provided with a position-coding pattern, comprising:
selectively activating, as a function of the position data, a position storage process and an audio feedback process;
wherein the position storage process stores the position data in a persistent-storage memory; and
wherein the audio feedback process correlates the position data with audio data and provides the audio data for output on a speaker device.

54. A system for interacting with position data representing a pen movement on a product provided with a position-coding pattern, comprising:
a position streaming module which is operable to provide the position data as a bit stream for output on a communications interface; and
an audio module which is operable to correlate the position data with audio data and to provide the audio data for output on a speaker device;
wherein operation of at least one the position streaming module and the audio module is selectively activated as a function of the position data.

55. The system of claim 54, wherein the position streaming module is included in a pen device which is operated to read said position-coding pattern, and wherein the position streaming module is further operable to store, in a buffer memory of the pen device, position data read from the position-coding pattern between initiation and establishment of a connection to an external device via the communications interface; and, after said establishment, to provide the position data stored in the buffer memory and position data read from the position-coding pattern following said establishment to the external device via the communications interface.

56. The system of claim 55, wherein the position streaming module is further operable to erase the data stored in the buffer memory if said connection fails to be established.

57. The system of claim 55, wherein the position streaming module is further operable to provide a buffer indicator via the communications interface, the buffer indicator identifying the extracted data that has been stored in the buffer memory before said establishment.

58. A method of interacting with position data representing pen movement on a product provided with a position-coding pattern, comprising:
selectively activating, as a function of the position data, a position streaming process and an audio feedback process;
wherein the position streaming process provides the position data as a bit stream for output on a communications interface; and
wherein the audio feedback process correlates the position data with audio data and provides the audio data for output on a speaker device.
